(19) United States
(12) Patent Application Publication
(10) Pub. No.: US 2026/0349236 A1
(43) Pub. Date: Nov. 5, 2026

(54) FRAME AGGREGATION USING FILTER FOR REDUCING CHARGING ARTIFACTS

(71) Applicants: Carl Zeiss Multisem GmbH, Oberkochen (DE); HITACHI HIGH-TECH CORPORATION, Tokyo (JP)

(72) Inventors: Thomas DIETERLE, Murrhardt (DE); Bjoern MIKSCH, Heidenheim (DE); Hajime KAWANO, Tokyo (JP); Koichi KURODA, Tokyo (JP); Kengo GOTO, Tokyo (JP); Daichi FUJII, Tokyo (JP)

(21) Appl. No.: 19/709,208

(22) Filed: Jun. 16, 2026

Related U.S. Application Data
(63) Continuation of application No. PCT/EP2024/087224, filed on Dec. 18, 2024.

(30) Foreign Application Priority Data
Dec. 20, 2023 (DE) 10 2023 136 062.0

(51) Int. Cl. G02B 21/36; G02B 21/00; G06T 5/50; G06V 20/69

(52) U.S. Cl. CPC G02B 21/367; G02B 21/002; G06T 5/50; G06V 20/693; G06T 2207/10061; G06T 2207/20221

(57) ABSTRACT

Techniques of post-processing a frame-aggregation sequence of images acquired using a charged particle microscope are disclosed. A filter is applied to regulate an impact of each image of the sequence of images onto an aggregate image. In an example, one or more images at a beginning of the sequence are discarded, i.e., do not affect the aggregate image at all. This helps to reduce charging artifacts and obtain an aggregate image having an improved image quality.

### CROSS-REFERENCE TO RELATED APPLICATION

This is a Continuation of International Application PCT/EP2024/087224, which has an international filing date of Dec. 18, 2024, and the disclosure of which is incorporated in its entirety into the present Continuation by reference. This Continuation also claims foreign priority under 35 U.S.C. § 119(a)-(d) to and also incorporates by reference, in its entirety, German Patent Application DE 10 2023 136 062.0 filed Dec. 20, 2023.

### FIELD

Various examples of the disclosure generally pertain to control and operation of particle raster scanning microscopes. Various examples specifically pertain to frame aggregation.

### BACKGROUND

In scanning electron microscopes (SEMs) or other types of charged particle raster scanning microscopes (e.g., Helium ion microscopes), the imaging time is largely defined by the time it takes to scan the sample with the electron beam. To increase the signal-to-noise ratio (SNR), it is possible to increase the so-called dwell time—the time spent by the particle beam in one pixel. Larger dwell times lead to larger imaging times and improved SNR.

On the other hand, various instabilities inside the SEM lead to the so-called “drift” -a gradual shift of the field of view (FOV) of the particle beam relative to the imaging object/sample. Underlying causes for drift include thermal drift, charging, stage instabilities, sample instabilities, or beam instabilities. The drift leads to a distortion of the acquired image usually observed as “skewing” or “shear” along X- or Y-direction with an amplitude proportional to the imaging time. This is illustrated in FIG. 1. FIG. 1 illustrates an image 2020 acquired using an SEM with a relatively long dwell time, e.g., 1 μs or longer for a 1×1 nm pixel. In FIG. 1 the distortions are clearly visible: depicted are semiconductor structures that include straight lines and circular structures arranged in a square pattern. The straight lines are bent and the square pattern is skewed. Circular structures are skewed and appear elliptical.

Techniques are known in the art to mitigate such drift-driven distortions. For instance, to mitigate charging, the sample may be pre-charged, charge control electrodes may be used, or gas injection may be used. Operation at elevated pressure or vector-scan strategies are other examples. These aforementioned techniques physically affect the imaging process. Another approach relates to postprocessing and is called frame aggregation or drift-corrected frame integration. When applying frame aggregation-as illustrated in FIG. 2—instead of acquiring a single image taken with long dwell time (as in FIG. 1) and having high SNR but also large distortions, a sequence of “fast” images (or frames) 2001, 2002, 2003, 2004 with low-SNR and low distortions is acquired at a relatively short dwell time. These images 2001, 2002, 2003, 2004 are then aggregated (typically a pixel-wise summation), at 2000. This yields an aggregate image 2011. Sometimes, it is observed that the aggregate image 2011 appears “blurred”, cf. FIG. 2; or includes further artifacts.

Such artifacts in the aggregate images are also observed for multi-beam SEMs (MSEMs). MSEMs have been employed to provide large-scale composite images of samples. Here, multiple sequences of images are acquired contemporaneously for multiple FOVs using multiple electron beams; the multiple FOVs that arranged in a spatial pattern, to thereby define a composite FOV. The images of each sequence are aggregated, using frame aggregation. The respective aggregate images thereby obtained are combined to form a composite image. Multiple composite images can be acquired one after another and stitched to obtain a stitched FOV.

### SUMMARY

Accordingly, a need exists for advanced frame-aggregation techniques for SEMs and MSEMs. In particular, a need exists for frame aggregation with reduced artifacts such as blur artifacts, distortion artifacts, shading artifacts, defocus artifacts, etc.

This need is met by the features of the independent claims. The features of the dependent claims define embodiments.

Hereinafter, techniques are disclosed for post-processing of acquired sequences of images of a sample. The images are acquired using a particle raster scanning microscope such as a SEM or MSEM. The disclosed techniques are applicable to, both, single-beam particle raster scanning microscopes as well as to multi-beam particle raster scanning microscopes. The techniques generally relate to frame aggregation. Various techniques are based on the finding that when using frame aggregation, dynamics in the charge-up phase of the sample may undesirably degrade the image quality of images; the respective effect is particularly pronounced at a beginning of the respective sequence. Images acquired at the beginning of a frame-aggregation sequence while charge-up of the sample is occurring can suffer from blur, complex shaped shadings, and/or complex shaped distortions. To avoid or at least reduce such artifacts affecting the image quality of the aggregate image, a filter for selectively discarding at least one image per sequence is disclosed.

A method for use in a processing device is disclosed. The processing device is associated with a particle raster scanning microscope. The method includes controlling the particle raster scanning microscope to acquire, for each of one or more particle beams, a respective sequence of images of a sample. The method also includes, for each of the one or more sequences of images, applying a filter for selectively discarding at least one image of the respective sequence and subsequently aggregating the multiple remaining images of the respective sequence, to thereby obtain a respective aggregate image of the sample.

By discarding certain images of the sequence, it becomes possible to suppress the propagation of artifacts from the acquired images to the aggregate image. In particular, it is possible to selectively discard those images that are a root cause of artifacts otherwise present in the aggregate image.

If compared to reference implementations that use, e.g., a so-called flood gun to pre-charge the sample, the suppression of artifacts is shifted to the post-processing regime while minimizing the impact onto the imaging process. This often enables more flexible and/or faster image acquisition. It also alleviates the need for separate hardware such as a flood gun or other pre-chargers for pre-charging the sample.

Furthermore, by discarding certain images, artifacts due to dynamic charging effects can be mitigated. These dynamic charging effects pertain to charge built-up or charge diffusion on a timescale associated with a typical image acquisition time duration. If compared to reference implementations that employ a pre-illumination using a flood gun and subsequent acquisition of multiple images in a frame averaging process, the time duration between pre-charging and image acquisition is longer. Thus, such dynamic charging effects cannot be effectively mitigated in the reference implementations.

In an example, the filter selectively discards at least one image from a sequence of images depending on a sequence position of the images along the respective sequence. The decision to discard an image may thus be made depending on its location within the sequence, which is referred to as the “sequence position”. The sequence position may relate to the relative location of each image within the sequence, such as the beginning, middle, or end of the sequence. Such implementation may have the effect of providing a simple and efficient way to improve image quality of the aggregate image, as it eliminates the need to calculate complex quality metrics for each image, e.g., using an image analysis. By relying (e.g., solely) on sequence position, the filter can quickly identify and discard poor-quality images, resulting in improved overall image quality with minimal computational overhead.

For instance, images at a beginning of the respective sequence may be discarded. For instance, the N first images may be discarded, wherein N is a threshold sequence position and may equal 1 or 2 etc. For instance, the parameter value N may be predetermined, e.g., based on an image analysis pre-executed (e.g., based on an earlier sequence of images).

Discarding images up to a threshold sequence position is based on the finding that in particular those images at a beginning of a sequence may suffer from charging artifacts that materialize as, e.g., drift or shaped shading.

Alternatively or additionally to determining the sequence position and discarding a given image depending on its sequence position along the respective sequence, each image may be analyzed in order to determine whether a certain artifact is present or not in the analyzed image. Thus, an image analysis may be executed for each image along a given sequence of images. For example, for each image along a given sequence of images, it may be determined whether a charging artifact is present. Then, the filter may selectively discard a given image if the charging artifact has been found in the given image using the image analysis.

Such scenario has the advantage that it relies less on prior knowledge regarding presence or absence of charging artifacts in certain images along a respective sequence; instead, ad hoc determination of presence or absence of charging artifacts can be executed. On the other hand, the required computational resources may be higher-which may limit prolong the post-processing duration, in particular for MSEMs: here, the amount of imaging data per time unit is significant due to parallelization of the image acquisition for multiple electron beams.

Generally speaking, charging artifacts may result in a certain feature pattern visible in a given image. For instance, charging artifacts may result in a distortion of the structures in the image. Shaped shading may be observed. Such feature patterns that are characteristic for a charging artifact may be detected using an appropriate model, e.g., a machine-learning model that has been trained to recognize charging artifacts for certain samples. The training may be sample specific, e.g., specific for a certain wafer topography, certain semiconductor structures, certain types of biological samples. In particular, such model used to reveal charging artifacts may operate based on prior knowledge regarding the depicted structures of the samples.

For instance, the nominal shape of certain semiconductor structures may be known, e.g., from the lithography mask or a design pattern. Referring to FIG. 1 and FIG. 2, it may be known that certain semiconductor trenches should be linear. Then, deviations from that linear structure may be revealed by the model. It is also possible to reveal charging artifacts by an image-to-image comparison of multiple images along a sequence. This is based on the finding that charging artifacts vary depending on the illumination charge that has been deposited at a given FOV so that charging artifacts will be pronounced or less pronounced depending on the sequence position. Thus, the charging artifacts may be revealed by performing an image-to-image comparison of multiple images along the sequence.

Alternatively or additionally, a user input may be used to identify artefacts. For instance, a user may annotate the different images and thereby specify whether they include charging artefacts.

In some scenarios, it is feasible that the imaging process is repeated multiple times, e.g., for multiple stage positions of a sample stage. Then, stitching can be applied to obtain a stitched FOV.

Thus, upon controlling the particle raster scanning microscope to acquire, for each of the one or more particle beams, a respective sequence of images of the sample, the particle raster scanning microscope may be controlled to displace a sample stage to a new stage position so as to subsequently control the particle raster scanning microscope to acquire, for each of the one or more particle beams, a respective sequence of further images of the sample.

Thereby, for each stage position, one or more aggregate images are obtained and may be stitched to extend the field of view.

One or more filter parameters used for image acquisition at the first stage position may be re-used for the second or any subsequent stage position. This means that the filter is parameterized initially and then the filter parameter values are re-used for subsequent stage positions. In such a scenario of stage-supported stitching, the filter may be parameterized once—e.g., for the first stage position—and then applied multiple times without re-parameterization at multiple further stage positions.

For instance, a filter parameter value—e.g., the threshold sequence position, as previously discussed—may be determined based on one or more of the images acquired at the first stage position, e.g., using an image analysis to determine which images suffer from charging artifacts and/or using user input; when applying the filter for selectively discarding at least one further image acquired at a second further stage position, that filter parameter value may again be used.

Another example filter parameter for which the filter parameter value may be initially determined and then re-used multiple times would be a threshold illumination charge. For instance, it may be determined that images suffer from charging artifacts until a certain charge has been used for illumination of the sample due to image acquisition. For instance, when acquiring images along a given sequence for frame aggregation, the illumination charge induced by the primary charged particles increases from image to image along the given sequence and even from image pixel to image pixel within a given image. It may be determined that charging artifacts decrease upon a certain threshold illumination charge has been reached.

Parametrizing the filter in a first stage position and then reusing the values of one or more filter parameters that have been parametrized at the first stage position for one or more subsequent stage positions has the advantage that it is possible to provide a sample-specific parameterization of the filter which usually enables to achieve better results for the final aggregate image. For instance, different samples typically have different charging properties so that by parametrizing the filter for a given sample the sample-specific charge-up can be considered. On the other hand, due to repetitive structures present in a certain sample, it has been observed that the charge-up properties do not significantly vary for different lateral positions across a certain sample. Thus, by initially parametrizing the filter and then re-using the values of one or more filter parameters for different lateral positions, an optimized filter may be used while avoiding extensive overhead due to re-parameterization of the filter for every stage position. This, in particular, is helpful for situations in which a filter parameter value is determined based on a user input associated with acquired images at a given stage position; usually, user input is labor intensive and requires significant time. Thus, providing the user input once and then re-using the parameterization for multiple subsequent stage positions of a stitching process balances sample-specific filter adaptation and time overhead.

As will be appreciated from the above, charge-up artifacts are mitigated by appropriately filtering images that are acquired. The imaging process may remain unaffected. In particular, it may not be required to delay image acquisition until a sample has been pre-charged, e.g., using a flood gun. In some examples, it is nonetheless possible to adjust the imaging process in correlation with the filtering. For instance, imaging parameter values may be different for images that are to be discarded by the filter and images that are not to be discarded by the filter: If the filter is pre-parametrized so that certain images, e.g., up to a threshold sequence position and/were up to a threshold illumination charge, are to be discarded, then at the time of image acquisition it is known whether a particular image will be discarded or will be retained. This can be used to tailor the values of one or more imaging parameters for different images along a given sequence. For instance, imaging parameter values may be chosen to accelerate image acquisition for those images at the beginning of a sequence that are discarded by the filter. This may include reducing dwell time but at the same time increasing the beam current, e.g., so that the illumination dose per area unit remains constant. A beam spot size on the sample may be increased while reducing the number of raster points, e.g., so that the illumination dose per spatial area remain constant.

Above, techniques for filtering have been explained in which a given sequence of multiple images acquired using a certain charged particle beam is filtered. The techniques above may be applied to multi-beam particle raster scanning microscopes, e.g., an MSEM. Here, multiple sequences of images are contemporaneously acquired using multiple charged particle beams. Each sequence can be filtered.

Generally, certain filter parameter values may be re-used across different sequences of images. For instance, all images up to a given sequence position may be discarded, irrespective of the particular sequence. It would, however, also be possible that different filter parameter values are used for the filter depending on the particular sequence that is being filtered. In an MSEM, charge-up may occur differently for beams at a center of the beam pattern and beams at an edge of the beam pattern. In such scenarios, it may be helpful to, e.g., to use different threshold sequence positions and/or different threshold illumination charges for different beams.

A processing device is disclosed. The processing device is configured to perform such method as described above.

A system is disclosed. The system includes the processing device and a multi-beam particle raster scanning microscope.

As will be appreciated from the above, by discarding one or more images of a image sequence, a prioritization of the images is effected. In particular, the discarded image is down-prioritize to no impact on the respective aggregated image. There are other concepts available to determine a prioritization amongst the images of a sequence of images. For instance, a weighting may be used which does not altogether discard at least one image but rather regulates that the impact of at least one image onto the aggregated image is smaller than the impact of at least one other image of the same sequence, when executing the frame aggregation.

A method for use in a processing device associated with a particle raster scanning microscope is disclosed. The method includes controlling the particle raster scanning microscope to acquire, for each of one or more particle beams, a respective sequence of images of the sample. The method also includes, for each of the one or more sequences of images, applying a filter for determining a weighing factor for each image of the respective image and subsequently performing a weighted aggregation of the images of the respective sequence, to obtain the respective aggregate image of the sample, the weighted aggregation being depended on the weighting factors of each image.

It is to be understood that the features mentioned above and those yet to be explained below may be used not only in the respective combinations indicated, but also in other combinations or in isolation without departing from the scope of the disclosure. For illustration, concepts disclosed above in the context of a filter that selectively discards one or more images of the sequence may be equally applicable for a filter that determines weighting factors for the images. Here, if the 1st concept of the filter determines to discard a certain image, it would be likewise possible that the second concept of the future sets a relatively small weighting factor for that image so that the respective image is only having a comparatively limited impact on the aggregated image. For instance, such filter may determine the weighting factor depending on a sequence position of the images. For instance, at least one image at the beginning of the respective sequence may be associated with a weighting factor that suppresses the impact of that image onto the aggregated image. The filter may also be dependent on an outcome of an image analysis, as disclosed above. Concepts with respect to determining a filter parameter value are equally applicable to such implementation of the filter.

### BRIEF DESCRIPTION OF THE DRAWINGS

FIG. 1 schematically illustrates an image acquired using a SEM using a relatively long dwell time,

FIG. 2 schematically illustrates frame averaging of multiple images acquired using a SEM using a relatively short dwell time,

FIG. 3 schematically illustrates an MSEM according to various examples,

FIG. 4 schematically illustrates a spatial pattern of multiple FOVs of an MSEM according to various examples,

FIG. 5 schematically illustrates a sequence of multiple images and frame averaging according to various examples,

FIG. 6 is a flowchart of a method according to various examples, and

FIG. 7 schematically illustrates a processing device according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of operating and controlling a single-beam or multi-beam charged particle raster scanning microscope will be disclosed. Specifically, techniques will be explained for SEMs and MSEMs, but other types of particle raster scanning microscope may be employed as well.

Hereinafter, techniques of frame aggregation are disclosed. Here, a sequence of multiple images (also referred to as frames) is acquired and multiple of those images of the sequence combined, e.g., averaged. They may also be registered with each other; however, this is out-of-scope of the subject disclosure. An aggregate image is thereby obtained. The aggregate image has higher signal-to-noise ratio (SNR) if compared to the individual images of the sequence. For an MSEM, multiple sequences of images are contemporaneously acquired using multiple electron beams and for multiple FOVs; these multiple FOVs are adjacent to each other and may even overlap with each other. The arrangement of the FOVs corresponds to a beam pattern of the electron beams.

Various techniques are based on the finding that accumulation of electrons used for illumination of the sample as part of an imaging process (i.e., when raster scanning across the sample to acquire image pixels) can lead to sample charging which then leads to inferior image resolution and image quality, i.e., low SNR as well as to artifacts. In reference implementations, this can often render images meaningless and useless. Frame averaging can then fail. According to the techniques disclosed herein, it is possible to mitigate such restrictions and drawbacks by selecting and aggregating only useful images which results in high resolution, artefact free, high SNR images. A respective filter is applied. The filter prioritizes amongst the images of a sequence, e.g., by discarding certain images, or increasing or decreasing the impact that a given image has on the aggregate image vis-á-vis the impact that another image has on the aggregate image.

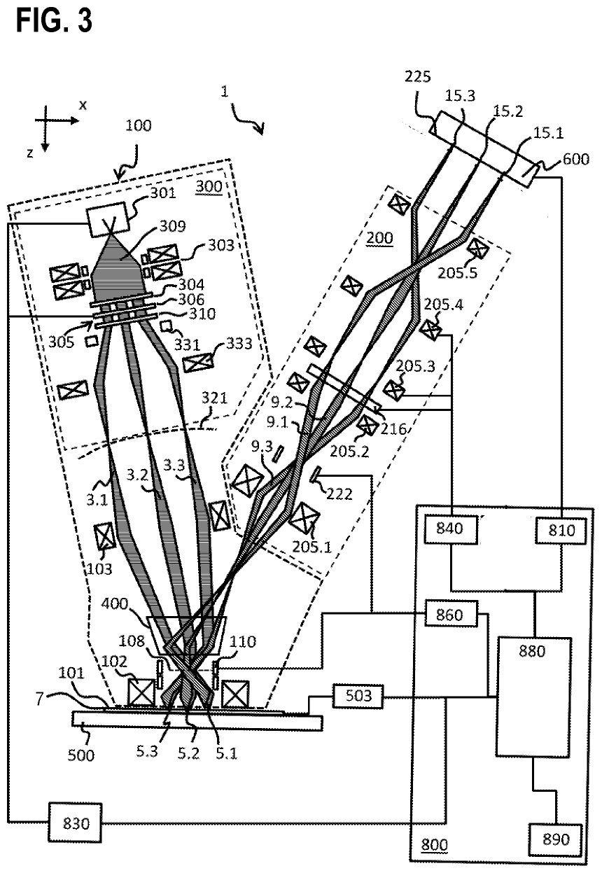

FIG. 3 is a schematic illustration of an MSEM 1. Further information relating to such MSEMs and components used therein, such as, for instance, particle sources, multi-aperture plate and lenses, can be obtained from the international patent applications WO 2005/024881, WO 2007/028595, WO 2007/028596, WO 2011/124352 and WO 2007/060017 and the German patent applications having the publication numbers DE 10 2013 016 113 A1 and DE 10 2013 014 976 A1The respective disclosures of each of these applications in their full scope are incorporated by this reference into the present application.

The MSEM 1 uses a plurality of charged particle beams (also referred to as beamlet) for imaging a sample 7. The MSEM 1 generates a plurality of J primary beamlets 3.1, 3.2, 3.3 which strike the sample 7 to generate interaction products, e.g., secondary electrons, which emanate from the sample 7, form secondary beamlets 9.1, 9.2, 9.3, and are subsequently detected.

Each one of the primary and secondary beamlets 3.1, 3.2, 3.3, 9.1, 9.2, 9.3 is formed and guided by a respective imaging subsystem of the MSEM 1. Each imaging subsystem is associated with a respective FOV. Images acquired by a respective imaging subsystem depict the respective FOV. The multiple FOVs are arranged in a spatial pattern to thereby define a composite FOV.

The primary beamlets 3.1, 3.2, 3.3 are formed by electrons which are incident on a surface of the sample 7 at a plurality of locations and generate a plurality of primary electron beam focus spots 5.1, 5.2, 5.3 that are spatially separated from one another.

The sample 7 to be examined can be of any desired type, e.g., a semiconductor wafer or a semiconductor mask, and can comprise an arrangement of miniaturized elements.

The surface of the sample 7 is arranged in a sample plane 101 of an objective lens system 102 of a first particle optical unit 100 (also referred to as illumination system).

A diameter of the minimal beam spots or focus spots 5.1, 5.2, 5.3 shaped in the sample plane 101 can be small. Exemplary values of this diameter are below four nanometers, for example three nm or less. The focusing of the primary beamlets 3.1, 3.2, 3.3 for shaping the focus spots 5.1, 5.2, 5.3 is carried out by the objective lens system 102. In this case, the objective lens system 102 can comprise a magnetic immersion lens. Further examples of focusing arrangements are described in the German patent DE 102020125534 B3, the entire content of which is hereby incorporated by reference into the present disclosure.

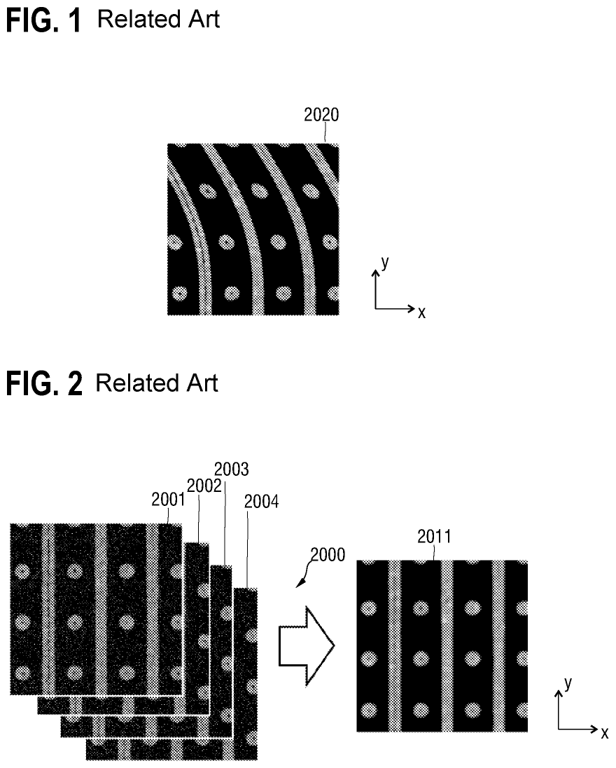

The number J of primary beamlets 3.1, 3.2 and 3.3 (i.e., the number of FOVs) may be five, 25, 90 to 100, or more (for sake of simplicity, only three primary beamlets 3.1, 3.2 and 3.3 with corresponding focus points 5.1, 5.2 and 5.3 are shown in FIG. 1).

In practice, the number of beamlets J, and hence the number of FOVs, can be chosen to be significantly greater, such as, for example, J=10×10, J=20×30 or J=100×100. Exemplary values of the pitch between the incidence locations and FOVs are 1 micrometer, 10 micrometers, or more, for example 40 micrometers.

The number of primary and secondary beamlets J defines the number of FOVs. Each imaging subsystem has a respective FOV. The respective FOV is defined by scanning the respective pair of primary and secondary beamlets (e.g., beamlets 3.1 and 9.1) over the sample 7 in the respective FOV.

The primary beamlets 3.1, 3.2, 3.3 striking the sample 7 generate interaction products, e.g., secondary electrons, back-scattered electrons, which emanate from the surface of the sample 7, or primary particles that have experienced a reversal of movement for other reasons. The interaction products emanating from the surface of the sample 7 are shaped by the objective lens system 102 to form the secondary beamlets 9.1, 9.2, 9.3. Secondary electrons included in the secondary beamlets 9.1, 9.2, 9.3 are used for imaging.

The MSEM 1 provides a detection beam path for guiding the plurality of secondary beamlets 9.1, 9.2, 9.3 to a secondary electron imaging system 200. The secondary electron imaging system 200 includes several electron-optical lenses 205.1 to 205.5 for directing the secondary beamlets 9.1, 9.2, 9.3 towards a spatially resolving detector system 600.

The imaging with the secondary electron imaging system 200 is strongly magnifying such that both the pattern of the primary beamlets on the wafer surface and the size and shape of focal points of the primary beamlets are imaged in much magnified fashion. By way of example, a scale factor/magnification is between 100x and 300x such that one nm on the wafer surface is imaged enlarged to between 100 nm and 300 nm. In an example, an image field of a multi-beam device with for example 100 μm diameter is enlarged to approximately 30 mm.

The primary beamlets 3.1, 3.2, 3.3 are generated in a beam generation apparatus 300 comprising at least one particle source 301 (e.g., an electron source), at least one collimation lens 303, a multi-aperture arrangement 305 and a first field lens 331 and a second field lens 333. The particle source 301 generates at least one diverging particle beam 309, which is at least substantially collimated by the at least one collimation lens 303, and which illuminates the multi-aperture arrangement 305. The multi-aperture arrangement 305 includes an aperture plate 304 (also referred to as filter plate or multi-hole aperture plate), which has a plurality of J openings formed therein in a first raster arrangement. Particles of the illuminating particle beam 309 pass through the J apertures or openings of the first aperture plate 304 and form the plurality J of primary beamlets 3.1, 3.2, 3.3. Particles of the illuminating particle beam 309 which strike the first aperture plate 304 are absorbed by this plate and do not contribute to the formation of the primary beamlets 3.1, 3.2, 3.3. A multi-aperture arrangement 305 usually has at least a further multi-aperture plate 306, for example a lens array, a stigmator array, or an array of deflection elements.

Together with the field lens 331 and a second field lens 333, the multi-aperture arrangement 305 focuses each of the primary beamlets 3.1, 3.2, 3.3 so that focal points are formed in an intermediate image surface 321. Alternatively, the beam foci and the intermediate image surface 321 can be virtual. The intermediate image surface 321 can be curved to pre-compensate a field curvature of the imaging system arranged downstream of the intermediate image surface 321.

The at least one field lens 103 and the objective lens system 102 provide a first imaging particle optical unit for imaging the surface 321, in which the beam foci are formed, onto the sample plane 101 such that a second pattern of focus spots 5.1, 5.2, 5.3 of the primary beamlets 3.1, 3.2, 3.3 is formed there. Typically, the surface 25 of the sample 7 is arranged in the sample plane 101, and the focal spots 5.1, 5.2, 5.3 are correspondingly formed on the object surface 25. The plurality of primary beamlets 3.1, 3.2, 3.3 form a crossover point 108, in the vicinity of which a first deflection scanner 110 is arranged. The first deflection scanner 110 is used to deflect the plurality of primary beamlets 3.1, 3.2, 3.3 collectively and synchronously such that the plurality of focus spots 5.1, 5.2, 5.3 are moved contemporaneously over the surface 25 of the sample 7. Raster scanning is implemented, thereby imaging the sample 7. The first deflection scanner 110 is driven by a scanning control unit 860 such that in an inspection mode of operation, a plurality of two-dimensional image data of the surface is acquired. Additionally, the MSEM 1 can include further static deflectors configured to adjust the position of the plurality of the primary beamlets 3.1, 3.2, 3.3.

The objective lens system 102 and the projection lenses 205 provide a secondary electron imaging system 200 for imaging the sample plane 101 onto an imaging plane 225. The objective lens system 102 is thus a lens or a lens system that is part of both the first and the second particle optical unit, while the field lenses 103, 331 and 333 belong only to the first particle optical unit 100, and the projection lenses 205 belongs only to the secondary electron imaging system 200.

A beam divider 400 is arranged in the beam path of the first particle optical unit 100 between the field lens 103 and the objective lens system 102. The beam divider 400 is also part of the second optical unit in the beam path between the objective lens system 102 and the projection lenses 205.

The first deflection scanner 110 is arranged in a primary electron beam path or in a joint electron beam path. In the example shown in FIG. 1, the secondary beamlets 9.1, 9.2, 9.3 transmit during use the first deflection scanner 110 in opposite direction and the scanning movement of the secondary beamlets 9.1, 9.2, 9.3 is partially compensated. The secondary electrons have typically a different kinetic energy compared to the primary electrons. Therefore, the scanning movement of the moving irradiation positions is only partially compensated. To compensate the scanning movement of the secondary beamlets 9.1, 9.2, 9.3, the collective beam deflector 222 is arranged in the secondary electron beam path.

The secondary electron imaging system 200 includes the second, collective beam deflector 222 which is arranged in the vicinity of a crossover point of the secondary beamlets 9.1, 9.2, 9.3. The second, collective beam deflector 222 is operated synchronously with the first deflection scanner 110 and compensates during use a beam deflection of the secondary beamlets 9.1, 9.2, 9.3 such that centers 15 of the beamlets 9 remain at constant position on the imaging plane 225. Thereby, each secondary beamlet 9 is kept within the area of a set of detection elements, which is assigned to the individual secondary beamlet 9.

The secondary electron imaging system 200 includes electron-optical lenses 205.1 to 205.5 to adjust a focus plane of the secondary beamlets 9.1, 9.2, 9.3. A defocus can be applied. The electron-optical lenses 205.1 to 205.5 can thus implement corrective elements to correct the focus plane. The electron-optical lenses 205.1 to 205.5 are shown as magneto-optical elements but are not limited to magneto-optical elements and can comprise also electro-static lens elements or stigmators. With the electron-optical lenses 205.1 to 205.5, the secondary beamlets 9.1, 9.2, 9.3 can be focused into the imaging plane 225 of the secondary electron imaging system 200.

The secondary electron imaging system 200 can include a plurality of further corrective elements, for example at least one of a multi-aperture array element, a deflector or an exchangeable aperture stop. Together with the objective lens system 102, the lenses serve to focus the secondary beamlets 9.1, 9.2, 9.3 on the spatially resolving detector system 600 and, in the process, allow to correct or compensate the magnification and rotation of the pattern of the secondary beamlets 9.1, 9.2, 9.3 in the imaging plane 225. Thereby, the pattern of the plurality of secondary beamlets 9.1, 9.2, 9.3 can stabilized. For example, a first and second magnetic lenses 205.4 and 205.5 (as further examples of corrective elements) are designed in reversed order to one another and have oppositely directed magnetic fields. A Larmor rotation of the secondary beamlets 9.1, 9.2, 9.3 can be compensated by suitably applying control signals to (driving) the magnetic lenses 205.4 and 205.5. The secondary electron imaging system 200—in the illustrated example-includes further corrective elements, specifically a multi-aperture plate 216.

The MSEM 1 furthermore is associated with a processing device 800 configured both for controlling the individual particle optical components of the multiple particle beam system and for evaluating and analyzing the signals obtained by the detector system 600. The processing device 800 can be separated from the MSEM 1 or can be part of the MSEM 1. The control or processing device 800 can be constructed from a plurality of individual electronic computers or electronic components. By way of example, the processing device 800 includes a control processor 880, a control module 840 for the control of the electro-optical elements of the secondary electron imaging system 200, and a control module 830 for the control of the electro-optical elements of the primary beamlet generation unit. The processing device 800 is further connected to a control module 503 for supplying a voltage to the sample 7, this voltage also being referred to as extraction voltage. Thereby, during use, an extraction field is generated between the objective lens system 102 and the surface 25 of the sample 7. During use, the extraction field decelerates the primary charged particles of the primary beamlets 3.1, 3.2, 3.3 before the object surface 25 is reached and generates an additional focusing effect on the plurality of primary beamlets 3.1, 3.2, 3.3. At the same time, the extraction field serves during use to accelerate the secondary particles out of the surface 25 of the sample 7.

Further, the processing device 800 includes the scanning control unit 860 for the raster scanning.

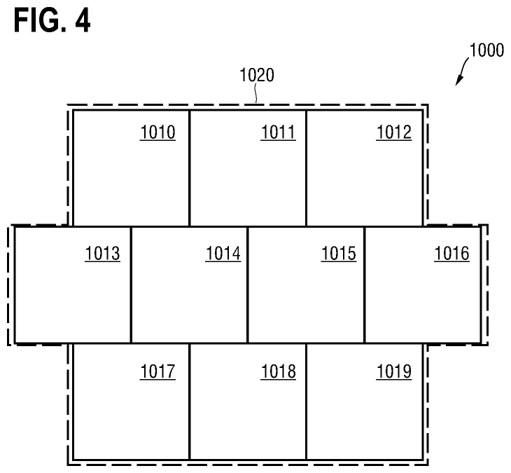

The detector system 600 includes a plurality of sets of detection elements with one set of detection elements for each secondary beamlet 9. During use, each set of detection elements is configured to record the intensity signal of the assigned secondary beamlet 9. The plurality of intensity signals for the plurality of secondary beamlets 9.1, 9.2, 9.3 is transferred to the image data acquisition unit 810, where the image data is processed and stored in memory 890. Accordingly, multiple images are acquired, one for each imaging subsystem. These multiple images (or an aggregated image determined based on images of respective sequences) can be combined to a composite image having a composite FOV. This is shown in FIG. 4.

FIG. 4 schematically illustrates a spatial pattern 1000 of multiple FOVs 1010-1019 associated with the contemporaneously scanned particle beams of the MSEM 1. These FOVs 1010-1019 are adjacent to each other. The spatial pattern 1000 is defined by a spatial pattern of multiple electron beams of the MSEM 1. Also illustrated is the associated composite FOV 1020 that is obtained by stitching respective images associated with each of the multiple FOVs 1010-1019.

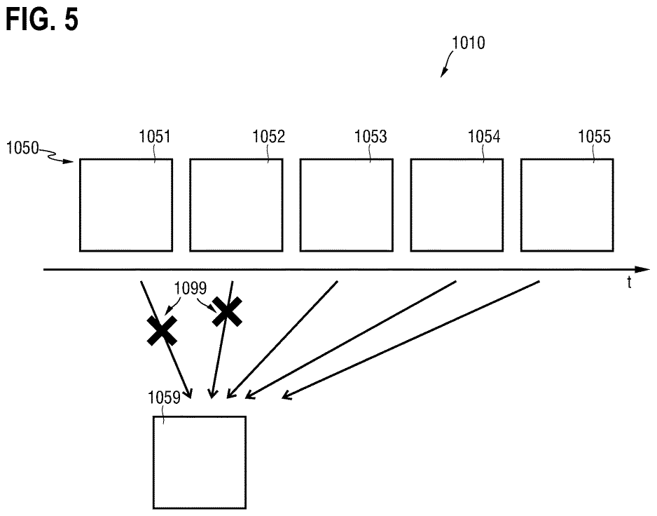

FIG. 5 illustrates aspects of frame aggregation. FIG. 5 illustrates—for the example of the FOV 1010 (all other FOVs of an MSEM can be treated similarly)—that a sequence 1050 of multiple images 1051, 1052, 1053, 1054, 1055 is acquired. A relatively short dwell time is used, e.g., shorter than 1 μs. It is then possible to aggregate the images, e.g., by a pixel-wise summation (frame aggregation).

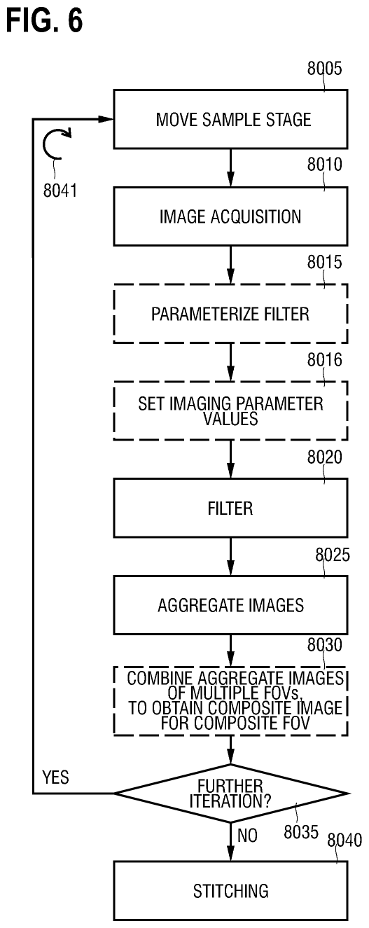

Prior to the aggregation, a filter 1099 is employed. In the scenario of FIG. 5, the filter 1099 discards the images 1051, 1052. These are the first two images of the sequence 1050. Generally, the filter may discard or suppress images at a beginning of the sequence 1050, e.g., up to a certain threshold sequence position or up to a certain threshold illumination charge. Details with respect to the filter 1099 are also explained in connection with the method of FIG. 6.

FIG. 6 is a flowchart of a method according to various examples. The method of FIG. 6 is for use in a processing device associated with a particle raster scanning microscope such as a SEM or the MSEM 1 illustrated in FIG. 3. For instance, the method of FIG. 6 can be executed by the processing device 800 illustrated in FIG. 3.

FIG. 6 is an iterative method including one or more iterations 8041. Each iteration 8041 is associated with a certain stage position, i.e., a certain relative position of the sample with respect to the incident one or more particle beams. The stage position is defined in box 8005. At box 8005, the sample stage onto which a sample is attached is moved to a certain stage position. This defines the illuminated area with respect to the sample. Each particle beam defines a FOV; if multiple particle beams are used, e.g., in an MSEM, a composite FOV is thereby defined (cf. FIG. 4). If multiple stage positions are used (i.e., if multiple iterations 8041 are used), then the multiple FOVs (for a SEM) or the multiple compositive FOVs (for an MSEM) can be further stitched together, to obtain a stitched FOV.

At box 8010, image acquisition is performed. For each of one or more particle beams, a respective sequence of images is acquired. Box 8005 can include controlling the MSEM to contemporaneously acquire sequences of respective images for each of multiple particle beams. Thereby, images for multiple FOVs are contemporaneously acquired.

Images are acquired using certain imaging parameter values. Imaging parameters with tunable values include: dwell time; beam spot size; raster spot distance; beam current. In one scenario, all images of a given sequence acquired using a certain beam employ the same imaging parameter values. For instance, the dwell time may be the same for all images of a given image sequence. In another scenario, certain images of a given sequence are acquired using different imaging parameter values than other images of that given sequence (details will be described in connection with box 8016).

At box 8015, a filter for prioritizing amongst the images of each sequence is parameterized. The filter may be for discarding at least one image per sequence is parameterized. Box 8015 is an optional box. For instance, box 8015 may be executed once, e.g., at the first iteration 8041; in all further iterations, box 8015 may be skipped. It would also be possible that the filter is fixedly pre-parameterized; so that box 8015 is not executed at all.

If box 8015 is executed, at least one filter parameter value of the filter is determined based on the images acquired in box 8010 of the same iteration 8041. Then, the respective filter parameter value or filter parameter values are used when applying the filter for selectively discarding at least one image per sequence. Example filter parameter values that configure the filter include a threshold sequence position along each sequence up to which images are discarded or down-prioritized and/or a threshold illumination charge. For acquiring image pixel information at a given raster point, a certain illumination charge is required. These illumination charges can be integrated and the integrated illumination charge can be compared against the threshold illumination charge. All images that include at least one pixel for which the integrated illumination charge is below the threshold illumination charge may be discarded. Alternatively, all images up to the threshold sequence position may be discarded.

If box 8015 is executed, multiple implementation options are available. In a first implementation option, a graphical user interface may be controlled to display the images of a given sequence of box 8010 of the same iteration 8041. The user may then provide a user input by selecting at least one image to be discarded via the graphical user interface. The user may select those images to be discarded that show significant charging artifacts. This enables determining the threshold sequence position or the threshold illumination charge. In a second implementation option, an image analysis e.g., using a machine-learned image classification model-may be executed and it may be determined, for each image, whether a certain charging artifact is present. This also enables determining the threshold sequence position or the threshold illumination charge.

At box 8016, it is optionally possible to set one or multiple imaging parameter values for any subsequent image acquisition, i.e., for subsequent iterations 8041 of box 8010. For instance, box 8016 may be executed once at the first iteration 8041; and subsequently skipped. It would be possible that box 8016 is executed in each iteration 8041 in which also box 8015 is executed. In some scenarios, image parameter values are fixedly set and box 8016 is not executed at all.

If box 8016 is executed, imaging parameter values may be adjusted for those images that are acquired but will be subsequently discarded by the respective application of the filter using the filter parameter value previously determined at box 8015. The adjusted imaging parameter values then remain valid for subsequent iterations 8041 of box 8010.

For instance, those images at a beginning of the sequence and up to the threshold sequence count of the filter to be applied may be acquired using a shorter dwell time, but a higher beam current if compared to those images beyond the threshold sequence count. For instance, the deposited charge per time unit and/or area unit may be constant across all images of the sequence. Generally, the imaging parameter values may be varied for those images that are to be discarded by the filter if compared to those images that will not be discarded by the filter. The imaging parameter values for those images that are to be discarded may be set so that the image acquisition time for acquiring a certain image is shortened if compared to those images that are not discarded. This typically is accompanied by a reduced image quality of the thus acquired images; on the other hand, the reduced quality does not negatively affect the quality of the aggregate images of the frame aggregation, because those images are discarded anyway by the filter.

At box 8020, the filter is applied. The filter may be pre-parametrized based on an execution of box 8015 in the current iteration 8041 or in a previous iteration 8041.

The filter results in a prioritization amongst the images of each acquired sequence. In an example, the filter discards at least one image of each acquired sequence of images of box 8010 in the current iteration 8041. This may be based on a sequence position of the images along the respective sequence. For instance, the filter may discard all images up to a threshold sequence position or up to a threshold illumination charge (e.g., as defined in box 8015). Such operation is relatively fast, because it is based on values that need not be measured or obtained from an image analysis. Alternatively, box 8020 may include performing an image analysis to determine whether a charging artifact is present in each of the images of a respective sequence. Then, depending on an outcome of the image analysis, a given image may be discarded or may be retained.

At box 8025, frame aggregation is executed. The non-discarded images of each sequence of images are aggregated. A pixel-wise averaging is a typical aggregation operation, but other examples are feasible. For each sequence, a respective aggregate image is obtained.

If multiple aggregate images are available, because a multi-beam particle raster scanning microscope such as an MSEM is employed, these aggregate images can be combined at box 8030 to obtain a composite image (cf. FIG. 4: composite FOV 1020).

At box 8035, it is judged whether a further iteration 8041 is required. If yes, a further iteration 8041 of box 8005 and following boxes is executed. Otherwise, the method may commence at box 8040.

At box 8040, it is optionally possible to stitch aggregate images or composite images available from multiple iterations 8041 of box 8025 or box 8030, to obtain a stitched image.

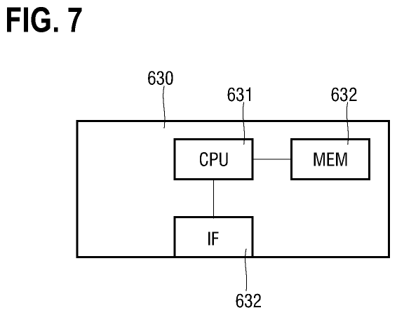

FIG. 7 schematically illustrates a processing device 630 that includes a processor 631 as well as the memory 632. The processing device 630 also includes a communication interface 632. For instance, the processor 631 may obtain images via the communication interface 632, e.g., from a particular rest the scanning microscope such as the MSEM 1. The processor 631 may also obtain the images by loading the images from an image repository via the communication interface 632. The processor 631 can load program code from the memory 632 and execute the program code. The processor 631, upon executing the program code, can perform techniques as disclosed herein, e.g. as previously discussed in connection with FIG. 6. The processor 631, upon executing the program code can perform techniques such as controlling the particle rest the scanning microscope to acquire one or more images of sequences, loading images of one or more sequences of images from a data repository, postprocessing images of one or more sequences, performing frame aggregation for images of one or more sequences, prioritizing amongst images of one or more sequences, applying a filter forward selectively discarding at least one image of one or more sequences, compensating charging artifacts, in particular dynamic charging artifacts, by applying a filter, controlling a graphical user interface to output one or more aggregate images, applying image stitching for images or aggregate images, etc.

Although the disclosure has been shown and described with respect to certain exemplary embodiments, equivalents and modifications will occur to others skilled in the art upon the reading and understanding of the specification. The present disclosure includes all such equivalents and modifications and is limited only by the scope of the appended claims.

For illustration, above, various techniques have been disclosed in which a filter is applied that discards at least one image of a sequence of images. Rather than discarding at least one image, the filter may be configured to determine weights for each image of the sequence of image so that a subsequent aggregation of the images takes into account these weights. Thereby, in frame aggregation, certain images of the sequence of images may have a higher impact than other images of the sequence. For example, those images that would be discarded using an implementation of the filter as disclosed above may have a relatively small impact on the aggregate image if compared to other images. Thus, more generally, while various techniques have been disclosed in the context of discarding images, more generally, images may be suppressed in the frame aggregation.

Moreover, the following CLAUSES are disclosed:

CLAUSE 1. A method for use in a processing device associated with a particle raster scanning microscope, wherein the method comprises:
controlling the particle raster scanning microscope to acquire, for each of one or more particle beams, a respective sequence of images of a sample, and
for each of the one or more sequences of images: applying a filter for selectively discarding at least one image of the respective sequence and subsequently aggregating multiple remaining images of the respective sequence, to obtain a respective aggregate image of the sample.

CLAUSE 2. The method of CLAUSE 1,
wherein the filter selectively discards, for each of the one or more sequences of images, the at least one image depending on a sequence position of the images along the respective sequence.

CLAUSE 3. The method of clause 1 or 2,
wherein the filter selectively discards, for each of the one or more sequences of images, the at least one image at a beginning of the respective sequence.

CLAUSE 4. The method of any one of the preceding CLAUSES,
wherein the method further comprises, for each of the one or more sequences of images: performing an image analysis to determine whether a charging artifact is present in each of the images of the respective sequence, wherein the filter selectively discards a given image if the charging artifact is present in the given image.

CLAUSE 5. The method of any one of the preceding clauses wherein the method further comprises:
upon controlling the particle raster scanning microscope to acquire, for each of the one or more particle beams, the respective sequence of the images of the sample, controlling the particle raster scanning microscope to displace a sample stage to a new stage position and further controlling the particle raster scanning microscope to acquire, for each of the one or more particle beams, a respective further sequence of further images of the sample, and
for each of the one or more further sequences of further images: applying the filter for selectively discarding at least one further image of the respective further sequence and subsequently aggregating multiple remaining further images of the respective further sequence, to obtain a respective further aggregate image of the sample.

CLAUSE 6. The method of clause 5, further comprising:
determining a filter parameter value of the filter based on one or more of the images, and
using the filter parameter value when applying the filter for selectively discarding the at least one image and the at least one further image.

CLAUSE 7. The method of CLAUSE 6,
wherein the filter parameter value is a threshold sequence position along the sequence and the further sequence up to which images are discarded.

CLAUSE 8. The method of CLAUSE 6,
wherein the filter parameter value is a threshold illumination charge.

CLAUSE 9. The method of any one of the preceding CLAUSES, wherein different ones of the images are associated with different values of one or more imaging parameters.

CLAUSE 10. The method of any one of the preceding clauses, further comprising:
determining a filter parameter value based on a user input associated with the images.

CLAUSE 11. The method of any one of the preceding CLAUSES, wherein the particle raster scanning microscope is a multi-beam particle raster scanning microscope configured for contemporaneously scanning multiple particle beams, wherein the one or more sequences of images comprise multiple sequences of images associated with the multiple particle beams, wherein the method further comprises:
combining the multiple aggregate images to obtain a composite image.

CLAUSE 12. A method for use in a processing device associated with a particle raster scanning microscope, wherein the method comprises:
controlling the particle raster scanning microscope to acquire, for each of one or more particle beams, a respective sequence of images of a sample, and
for each of the one or more sequences of images: applying a filter for determining a weighting factor for each image of the respective sequence and subsequently performing a weighted aggregation of the multiple remaining images of the respective sequence, to obtain a respective aggregate image of the sample, the weighted aggregation being dependent on the weighting factors.

CLAUSE 13. A processing device associated with a particle raster scanning microscope, the processing device comprising at least one processor and a memory, the at least one processor being configured to load program code from the memory and to execute the program code, the at least one processor, upon loading and executing the program code, being configured to:
control the particle raster scanning microscope to acquire, for each of one or more particle beams, a respective sequence of images of a sample, and
for each of the one or more sequences of images: apply a filter for selectively discarding at least one image of the respective sequence and subsequently aggregating multiple remaining images of the respective sequence, to obtain a respective aggregate image of the sample.

CLAUSE 14. The processing device of CLAUSE 13, wherein the at least one processor, upon loading and executing the program code, is configured to perform the method of any one of CLAUSES 1 to 11.

CLAUSE 15. A system, comprising the particle raster scanning microscope and the processing device of CLAUSE 13 or 14.

CLAUSE 16. A method for improved frame aggregation of images acquired using particle raster scanning microscope, the method comprising:
obtaining one or more sequences of images,
determining a prioritization of the images in each of the one or more sequences, and
executing a frame aggregation of the images of each of the one or more sequences in accordance with the prioritization of the images.

What is claimed is:

1. A method for use in a processing device associated with a particle raster scanning microscope, comprising:
controlling the particle raster scanning microscope to acquire, for each of one or more particle beams, a respective sequence of images of a sample, and
for each of the one or more sequences of images, applying a filter for selectively discarding at least one image of the respective sequence and subsequently aggregating multiple remaining images of the respective sequence, to obtain a respective aggregate image of the sample.

2. The method of claim 1,
wherein the filter selectively discards, for each of the one or more sequences of images, the at least one image depending on a sequence position of the images along the respective sequence.

3. The method of claim 1,
wherein the filter selectively discards, for each of the one or more sequences of images, the at least one image at a beginning of the respective sequence.

4. The method of claim 1, further comprising:
for each of the one or more sequences of images, performing an image analysis to determine whether a charging artifact is present in each of the images of the respective sequence,
wherein the filter selectively discards a given image if the charging artifact is present in the given image.

5. The method of claim 1, further comprising:
upon controlling the particle raster scanning microscope to acquire, for each of the one or more particle beams, the respective sequence of the images of the sample, controlling the particle raster scanning microscope to displace a sample stage to a new stage position and further controlling the particle raster scanning microscope to acquire, for each of the one or more particle beams, a respective further sequence of further images of the sample, and
for each of the one or more further sequences of further images, applying the filter for selectively discarding at least one further image of the respective further sequence and subsequently aggregating multiple remaining further images of the respective further sequence, to obtain a respective further aggregate image of the sample.

6. The method of claim 5, further comprising:
determining a filter parameter value of the filter based on one or more of the images, and
using the filter parameter value when applying the filter for selectively discarding the at least one image and the at least one further image.

7. The method of claim 6,
wherein the filter parameter value is a threshold sequence position along the sequence and the further sequence up to which images are discarded.

8. The method of claim 6, wherein the filter parameter value is a threshold illumination charge.

9. The method of claim 1, wherein different ones of the images are associated with different values of one or more imaging parameters.

10. The method of claim 1, further comprising:
determining a filter parameter value based on a user input associated with the images.

11. The method of claim 1,
wherein the particle raster scanning microscope is a multi-beam particle raster scanning microscope configured for contemporaneously scanning multiple particle beams, wherein the one or more sequences of images comprise multiple sequences of images associated with the multiple particle beams, said method further comprising:
combining the multiple aggregate images to obtain a composite image.

12. A method for use in a processing device associated with a particle raster scanning microscope, comprising:
controlling the particle raster scanning microscope to acquire, for each of one or more particle beams, a respective sequence of images of a sample, and
for each of the one or more sequences of images, applying a filter for determining a weighting factor for each image of the respective sequence and subsequently performing a weighted aggregation of the multiple remaining images of the respective sequence, to obtain a respective aggregate image of the sample, the weighted aggregation being dependent on the weighting factors.

13. A processing device associated with a particle raster scanning microscope, comprising at least one processor and a memory, the at least one processor being configured to load program code from the memory and to execute the program code, the at least one processor, upon loading and executing the program code, being configured to:
control the particle raster scanning microscope to acquire, for each of one or more particle beams, a respective sequence of images of a sample, and
for each of the one or more sequences of images, apply a filter for selectively discarding at least one image of the respective sequence and subsequently aggregating multiple remaining images of the respective sequence, to obtain a respective aggregate image of the sample.

14. A system, comprising the particle raster scanning microscope and the processing device of claim 13.

15. A method for improved frame aggregation of images acquired using a particle raster scanning microscope, comprising:
obtaining one or more sequences of images,
determining a prioritization of the images in each of the one or more sequences, and
executing a frame aggregation of the images in each of the one or more sequences in accordance with the prioritization of the images.
